(19) United States
(12) Patent Application Publication
(10) Pub. No.: US 2007/0235332 A1
(43) Pub. Date: Oct. 11, 2007

(54) Structure of gas sensor ensuring adhesion of electric lead

(75) Inventors: Tomio Sugiyama, Nagoya (JP); Takehito Kimata, Kariya-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/730,465

(22) Filed: Apr. 2, 2007

(30) Foreign Application Priority Data
Apr. 10, 2006 (JP) 2006-107814

(51) Int. Cl. G01N 27/26

(52) U.S. Cl. 204/424

(57) ABSTRACT

A gas sensor includes a sensor element and a porcelain insulator in which the sensor element is retained. The sensor element includes a measurement gas electrode, an electric lead extending from the measurement gas electrode, a dense protective layer covering the lead, and a porous protective layer disposed on the dense protective layer to cover the measurement gas electrode. The dense protective layer protrudes from an end of the porous protective layer by a distance of 5 mm or less, thereby ensuring the mechanical strength of the porous protective layer to minimize physical separation of the lead from the solid electrolyte layer. The base end of the porous protective layer lies inside porcelain insulator, thereby covering the whole of a portion of the sensor element exposed directly to the measurement gas with the porous protective layer to minimize the separation of the lead.

### CROSS REFERENCE TO RELATED DOCUMENT

The present application claims the benefit of Japanese Patent Application No. 2006-107814 filed on Apr. 10, 2006, the disclosure of which is totally incorporated herein by reference.

### BACKGROUND OF THE INVENTION

1. Technical Field of the Invention

The present invention relates generally to a gas sensor which is installed, for example, in an exhaust system of automotive internal combustion engines to measure a preselected component of exhaust emissions, and more particularly to an improved structure of such a gas sensor which is designed to ensure the adhesion of an electric lead to a sensor element.

2. Background Art

There are known oxygen sensors (also called O₂ sensors) that are electrochemical sensors equipped with a zirconia solid electrolyte body having opposed surfaces to which a measurement gas electrode exposed to a gas to be measured (will also be referred to as a measurement gas below) and a reference gas electrode exposed to a reference gas are affixed. For instance, Japanese Patent First Publication Nos. 60-36948 (U.S. Pat. No. 4,559,126), 60-36949 (U.S. Pat. No. 4,655,901), and 4-303753 disclose such a type of oxygen sensors designed to produce an electromotive force between the measurement gas electrode and the reference gas electrode as a function of concentration of oxygen contained in, for example, exhaust emissions from automotive internal combustion engines.

The gas sensor, as taught in a first one of the above publications, has an area of the measurement gas electrode which is exposed directly to the measurement gas and covered with a single porous protective layer. The measurement gas electrode connects with an electric lead which is covered with two layers: the porous protective layer and a dense layer disposed on the porous protective layer.

The gas sensor, as taught in the second publication, has the measurement gas electrode which is exposed directly to intense heat of the measurement gas and covered with a porous protective layer and a lead connecting with the measurement gas electrode which is exposed to a lower temperature and covered with a dense protective layer.

The gas sensor, as taught in the third publication, has the measurement gas electrode which is exposed directly to intense heat of the measurement gas and covered with a first porous protective layer and a lead connecting with the measurement gas electrode which is exposed to a lower temperature and covered with a second porous protective layer which is lower in gas permeability than the first porous protective layer. The lead is, however, exposed to a little of the measurement gas and thus works as part of the measurement gas electrode. This may result in an increased variation in characteristic of the gas sensor. This problem is objectionable in limiting current gas sensors utilizing the pumping activity.

The gas sensor, as taught in either of the first and second publications, has the lead connecting with the measurement gas electrode which is covered with the dense protective layer and thus does not encounter the above variation in characteristic of the gas sensor, but faces the problem of physical separation of the lead from its base layer (i.e., a solid electrolyte layer). For instance, in production processes of an oxygen sensor, a sensor element is usually exposed to a variety of water solutions or slurry when machined or inspected, so that the water in the water solutions enters the porous protective layer. The measurement gas electrode and the lead must be made of a porous material in terms of adhesion to a zirconia solid electrolyte layer to which they are to be affixed. The water having entered the porous protective layer, therefore, also penetrates into the measurement gas electrode and the lead. Afterwards, the sensor element is subjected to thermal treatment for the purpose of removing the water and burning the sensor element during a ceramic firing process. This will cause the water in the lead to be vaporized rapidly. When the pressure of such water vapor exceeds the mechanical strength of the dense protective layer covering the lead, it will result in breakage of the dense protective layer, which leads to physical separation of the lead from the solid electrolyte layer or breakage of the lead.

### SUMMARY OF THE INVENTION

It is therefore a principal object of the invention to avoid the disadvantages of the prior art.

It is another object of the invention to provide an improved structure of a gas sensor which is designed to ensure the adhesion of an electric lead to a sensor element.

According to one aspect of the invention, there is provided an improved structure of a gas sensor which may be employed in measuring the concentration of a given component of exhaust emissions from automotive engines. The gas sensor has a length with a top end and a base end opposite the top end and comprises: (a) a sensor element responsive to a concentration of a given gas to output a signal indicative thereof, the sensor element having a length with a top end and a base end opposite the top end; (b) a porcelain insulator in which the sensor element is retained with the top end thereof oriented to the top end of the gas sensor and the base end thereof oriented to the base end of the gas sensor; and (c) a housing in which the porcelain insulator is retained. The sensor element includes an oxygen ion-conductive solid electrolyte layer with a first and a second surface opposed to each other, a measurement gas electrode which is formed on the first surface of the ion-conductive solid electrolyte layer to be exposed to the gas and has a top end lying on a side of the top end of the sensor element and a base end lying on a side of the base end of the sensor element, a measurement gas electrode lead extending from the base end of the measurement gas electrode, a reference gas electrode formed on the second surface of the ion-conductive solid electrolyte layer to be exposed to a reference gas, a dense protective layer covering the measurement gas electrode lead, and a porous protective layer disposed on the dense protective layer to cover the measurement gas electrode. The dense protective layer has a length with a top end lying on the side of the top end of the sensor element and a base end lying on the side of the base end of the sensor element. The porous protective layer has a length with a top end lying on the side of the top end of the sensor element and a base end lying on the side of the base end of the sensor element. The base end of the dense protective layer protrudes from the base end of the porous protective layer by a distance of 5 mm or less. The base end of the porous protective layer lies inside the porcelain insulator. In other words, a sensing portion of the sensor element directly exposed to the gas is covered fully with the porous protective layer. The porous protective layer works to trap foreign matter, e.g., residual matter, such as carbon, contained in exhaust emissions from the automotive internal combustion engine, thereby minimizing the deposition of the foreign matter on the measurement gas electrode and the measurement gas electrode lead which is one of factors causing the separation of the lead from the solid electrolyte layer.

The protruding distance by which the dense protective layer protrudes from the base end of the porous protective layer 25 is 5 mm or less. This minimizes the separation of the measurement gas electrode lead arising from the entrance of water into the measurement gas electrode lead. For instance, in production processes of the gas sensor, the measurement gas electrode lead is exposed to water, so that it may enter the measurement gas electrode lead. When the moisture in the measurement gas electrode lead is vaporized during heat treatment of the sensor element, it expands within the measurement gas electrode lead. If the measurement gas electrode lead is covered almost fully with the dense protective layer, the water vapor will have nowhere to escape from the measurement gas electrode lead, which may result in breakage of the dense protective layer and separation or breakage of the measurement gas electrode lead. The porous protective layer covers most of the dense protective layer to enhance the mechanical strength of the dense protective layer, thus causing the water vapor, as produced in the measurement gas electrode lead, to escape from a portion of the measurement gas electrode lead not covered with the dense protective layer. A portion of the dense protective layer not covered with the porous protective layer, however, may lack the mechanical strength required to withstand the pressure of water vapor, as produced in the measurement gas electrode lead. In order to minimize this affair, the sensor element of this embodiment is designed to set the protruding distance by which the dense protective layer protrudes from the base end of the porous protective layer to 5 mm or less to minimize the portion of the dense protective layer not covered with the porous protective layer. This minimizes the separation of the measurement gas electrode lead from the solid electrolyte layer.

In the preferred mode of the invention, the gas sensor further comprises a sealing member and a second dense protective layer. The sealing member is disposed within the porcelain insulator to form a hermetic seal between the sensor element and the porcelain insulator. The second dense protective layer is interposed between the sealing member and the sensor element, thereby minimizing the separation of the measurement gas electrode lead from the solid electrolyte layer.

The second dense protective layer has a length with a top end lying on the side of the top end of the sensor element and a base end lying on the side of the base end of the sensor element. Each of the base end and the top end of the second dense protective layer may protrude from the sealing member by a distance of 5 mm or less.

According to another aspect of the invention, there is provided a gas sensor having a length with a top end and a base end opposite the top end which comprises: (a) a sensor element responsive to a concentration of a given gas to output a signal indicative thereof, the sensor element having a length with a top end and a base end opposite the top end; (b) a porcelain insulator in which the sensor element is retained with the top end thereof oriented to the top end of the gas sensor and the base end thereof oriented to the base end of the gas sensor; and (c) a housing in which the porcelain insulator is retained. The sensor element includes an oxygen ion-conductive solid electrolyte layer with a first and a second surface opposed to each other, a measurement gas electrode which is formed on the first surface of the ion-conductive solid electrolyte layer to be exposed to the gas and has a top end lying on a side of the top end of the sensor element and a base end lying on a side of the base end of the sensor element, a measurement gas electrode lead extending from the base end of the measurement gas electrode, a reference gas electrode formed on the second surface of the ion-conductive solid electrolyte layer to be exposed to a reference gas, a dense protective layer covering the measurement gas electrode lead, and a porous protective layer disposed on the dense protective layer to cover the measurement gas electrode. The dense protective layer has an opening through which the measurement gas electrode lead partially exposed, thereby permitting the water vapor, as developed in the measurement gas electrode lead when the sensor element is subjected to the heat treatment, to escape outside the dense protective layer, thus minimizing the breakage of the dense protective layer arising from the expansion of the moisture to avoid the separation of the measurement gas electrode lead from the solid electrolyte layer.

In the preferred mode of the invention, the gas sensor may further include a sealing member disposed within the porcelain insulator to form a hermetic seal between the sensor element and the porcelain insulator. The dense protective layer occupies an area of the sensor element placed in contact with the sealing member, thereby minimizing the separation of the measurement gas electrode lead from the solid electrolyte layer.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partially longitudinal sectional view which shows a structure of a gas sensor according to the first embodiment of the invention;

FIG. 2 is a plane view which shows a sensor element installed in the gas sensor of FIG. 1;

FIGS. 3(a), 3(b), 3(c), and 3(d) are exploded views of the sensor element of FIG. 2;

FIG. 4 is a longitudinal sectional view of the gas sensor, as illustrated in FIG. 1;

FIG. 5 is a plane view which shows a sensor element installed in the gas sensor of FIG. 1;

FIG. 6 is a transverse sectional view, as taken along the line A-A in FIG. 5;

FIG. 7 is a transverse sectional view, as taken along the line B-BA in FIG. 5;

FIG. 8 is a transverse sectional view, as taken along the line C-C in FIG. 5;

FIG. 9 is a transverse sectional view, as taken along the line D-D in FIG. 5;

FIG. 10 is a partially longitudinal sectional view which shows the layout of a dense protective layer and a porous protective layer in a thickness-wise direction of the sensor element of FIG. 5;

FIG. 11 is a partially longitudinal sectional view which shows a structure of a gas sensor according to the second embodiment of the invention;

FIG. 12 is a plane view which shows a sensor element installed in a gas sensor according to the third embodiment of the invention;

FIGS. 13(a), 13(b), 13(c), and 13(d) are exploded views of the sensor element of FIG. 12;

FIG. 14 is a view which shows a test sample placed in a water bath to obverse physical separation of a lead from a sensor element;

FIG. 15 is a view which shows energization of a heater to heat a test sample; and

FIG. 16 is a graph which shows a relation between a protruding distance L1 and the percentage of separation of a lead from a sensor element in test samples.

### DESCRIPTION OF THE PREFERRED EMBODIMENTS

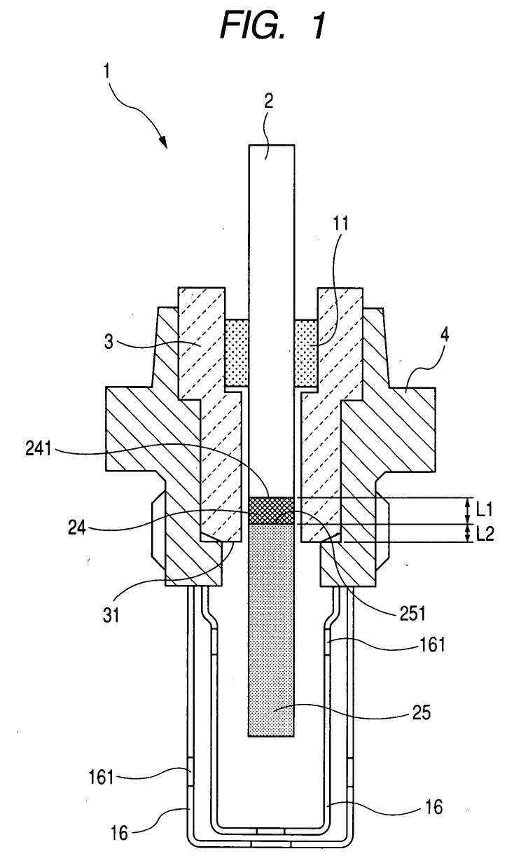

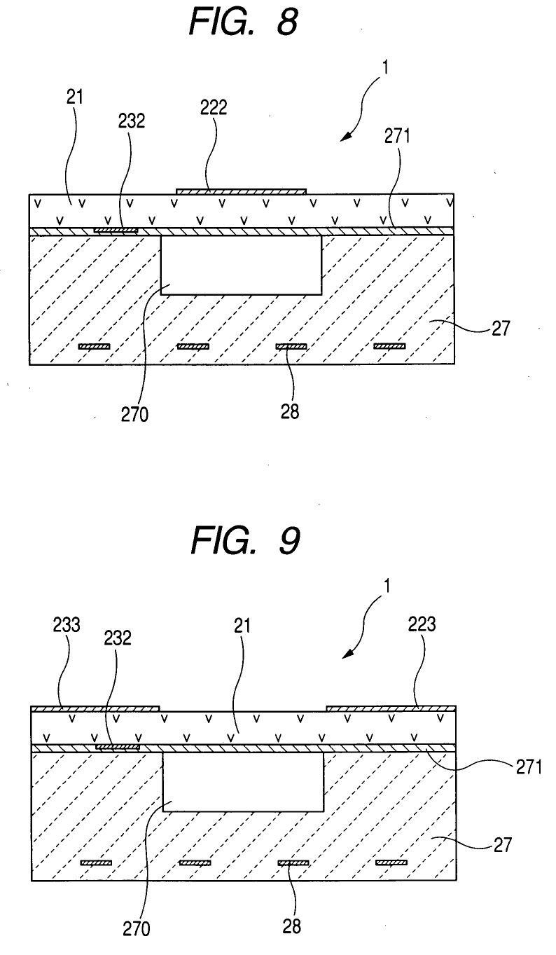

Referring to the drawings, wherein like reference numbers refer to like parts in several views, particularly to FIGS. 1 to 10, there is shown a gas sensor 1 according to the first embodiment of the invention which is designed to be installed in an exhaust pipe of an automotive internal combustion engine to measure the concentration of a component such as O₂, NOₓ, CO, or HC of exhaust gasses for burning control of the engine, for example.

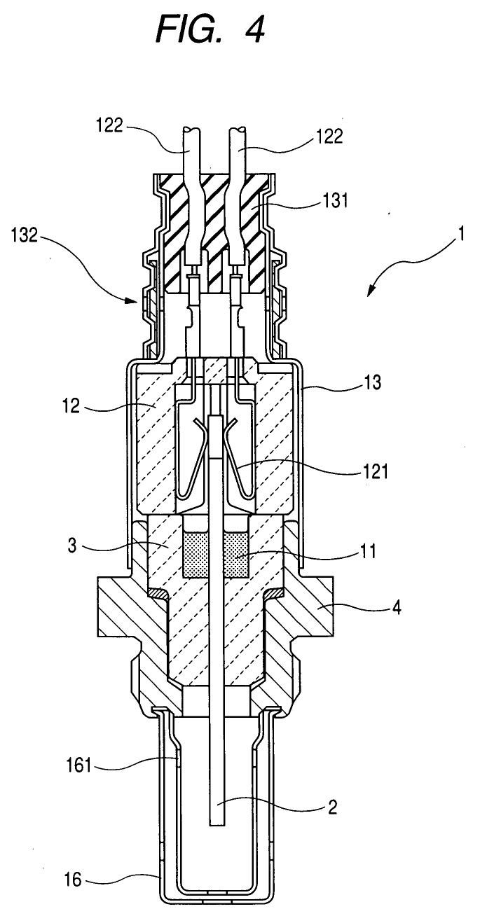

The gas sensor 1, as illustrated in FIGS. 1 and 4, includes a sensor element 2 sensitive to the measurement gas to produce a signal as a function of the concentration thereof, a porcelain insulator 3 in which the sensor element 2 is retained, and a housing 4 in which the porcelain insulator 3 is installed.

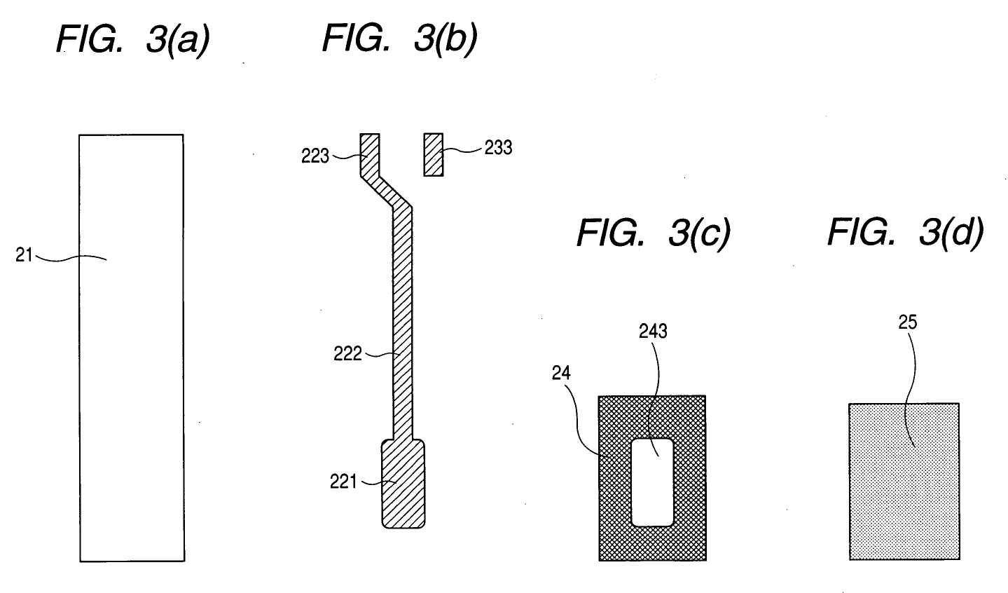

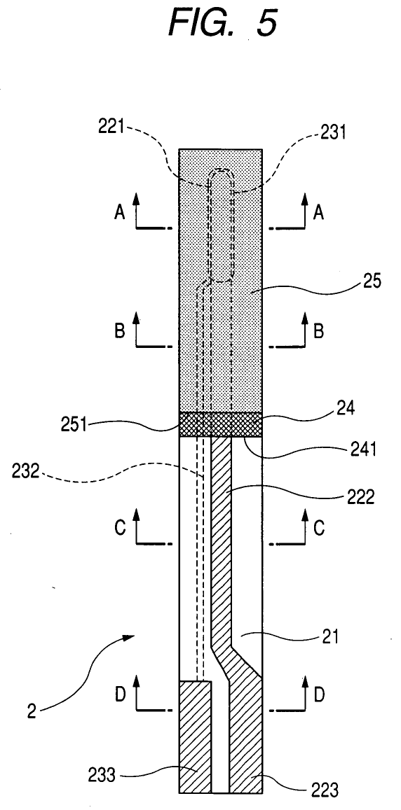

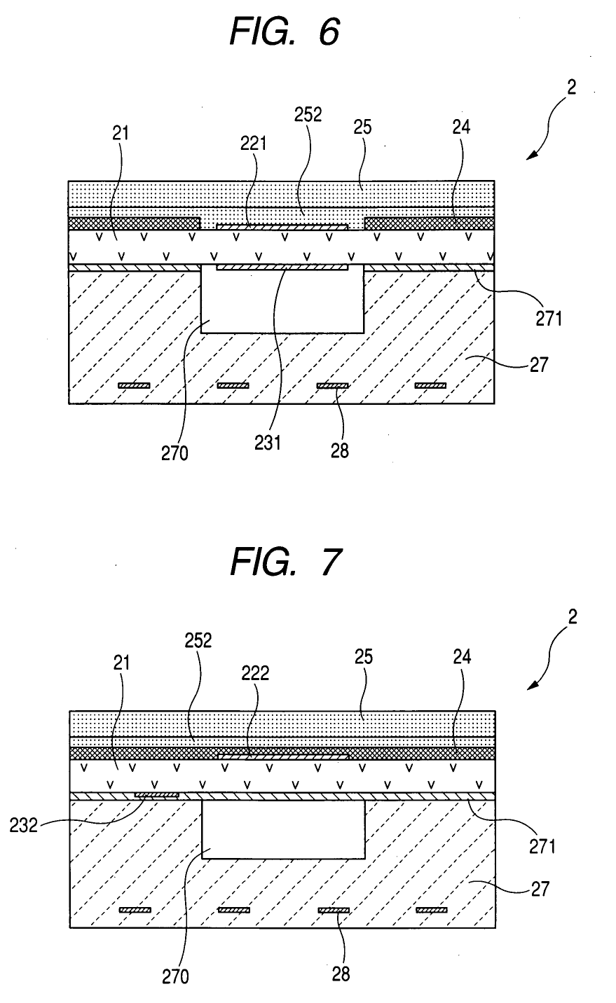

The sensor element 2 is, as clearly illustrated in FIGS. 3 and 6, equipped with an oxygen ion-conductive solid electrolyte layer 21. The solid electrolyte layer 21 has, as illustrated in FIGS. 5 and 6, affixed to one of opposed surfaces thereof a measurement gas electrode 221 to be exposed to the measurement gas. The measurement gas electrode 221 has an electric lead 222 extending from an end thereof. Similarly, the solid electrolyte layer 21 has, as illustrated in FIG. 6, a reference gas electrode 231 affixed to the other surface thereof.

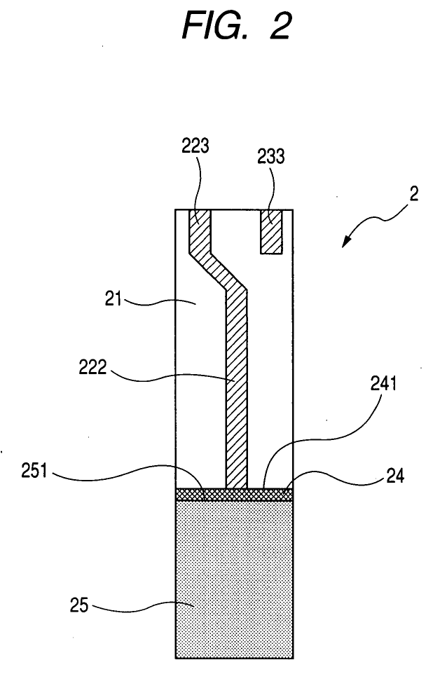

The sensor element 2 also includes, as illustrated in FIGS. 2, 6, 7, and 10, a dense protective layer 24 and a porous protective layer 25. The dense protective layer 24 is designed to almost block the transmission of the measurement gas therethrough and partially covers the lead 222. The porous protective layer 25 is placed on the dense protective layer 24.

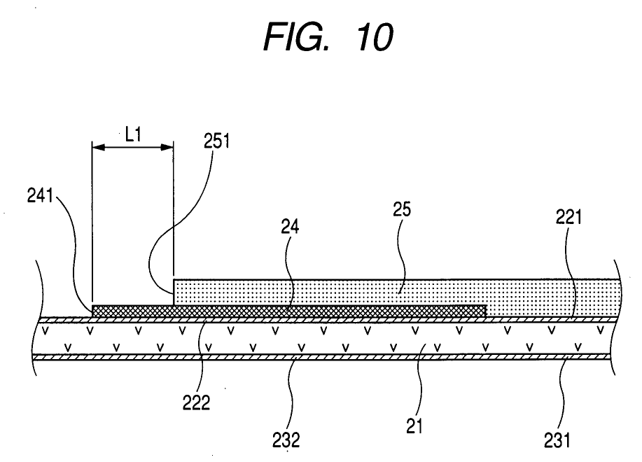

The dense protective layer 24, as can be seen from FIGS. 1 and 10, protrudes from a base end 251 (i.e., an upper end, as viewed in FIG. 1) of the porous protective layer 25 by a distance L1 of 5 mm or less. The base end 251 of the porous protective layer 25 is located inside the porcelain insulator 3. In other words, the base end 251 lies closer to a base end (i.e., an upper end, as viewed in FIG. 1) of the porcelain insulator 3 than the top end 31 (i.e., a lower end, as viewed in FIG. 1) of the porcelain insulator 3.

Specifically, the protruding distance L1 is an interval between the base end 241 of the dense protective layer 24 and the base end 251 of the porous protective layer 25 and, as described above, 5 mm or less. The distance L2 between the base end 251 of the porous protective layer 25 and a top end 31 of the porcelain insulator 3 is greater than zero (0).

The sensor element 2, as illustrated in FIGS. 5 to 9, has a sensing portion on the side of a top end thereof which is sensitive to the measurement gas and equipped with the measurement gas electrode 221 and the reference gas electrode 231.

The measurement gas electrode 221 is, as clearly shown in FIGS. 3(a) to 3(d) and 6, affixed to the surface of the solid electrolyte layer 21. The dense protective layer 24 has, as illustrated in FIG. 3(c), an opening or window 243 and is affixed to the surface of the solid electrolyte layer 21, so that the measurement gas electrode 221 is exposed from the window 243 of the dense protective layer 24. The porous protective layer 25 shown in FIG. 3(d) is glued, as clearly illustrated in FIGS. 6 and 10, to the dense protective layer 24 through a bonding layer 252 so that it covers the dense protective layer 24 and the measurement gas electrode 221. The bonding layer 252 is designed to be identical in function with the porous protective layer 25 so that it works as part of the porous protective layer 25.

The sensor element 2 also includes a base layer 27 which is affixed through a bonding layer 272 to the surface of the solid electrolyte layer 21 on which the reference gas electrode 231 is disposed. The base layer 27 has formed therein a groove which defines a reference gas chamber 270 along with the solid electrolyte layer 21 to which the reference gas electrode 231 is exposed. In use of the gas sensor 1, the reference gas chamber 270 is filled with fresh air as the reference gas.

The base layer 27 has embedded therein a heater 28 which works to heat the sensor element 2 up to a desired activation temperature at which the sensor element 2 will be activated to produce an output correctly.

The reference gas electrode 231, as illustrated in FIG. 5, has an electric lead 232 extending from an end thereof. The lead 232 connects with an electrode terminal 233 affixed to the base end of the sensor element 2. Similarly, the lead 222 of the measurement gas electrode 221 connects with an electrode terminal 223 affixed to the base end of the sensor element 2.

The solid electrolyte layer 21 is made of zirconia. The dense protective layer 24, the porous protective layer 25, the bonding layers 252 and 272, and the base layer 27 are each made of alumina.

The measurement gas electrode 221, the lead 222 extending from the measurement gas electrode 221, the reference gas electrode 231, the lead 232 extending from the reference gas electrode 231, and the electrode terminals 223 and 233 are each made of cermet formed by a mixture of metal, such as platinum, and ceramic.

A glass sealing member 11 is, as clearly illustrated in FIGS. 1 and 4, disposed within a base end portion of the porcelain insulator 3 to form a hermitical seal between the porcelain insulator 3 and the sensor element 2.

A protective cover assembly 16 is installed in an annular groove formed in a top end (i.e., a lower end, as viewed in FIG. 4) of the housing 4. The gas cover assembly 16 is of a double-wall structure made up of made up of an outer cover and an inner cover both of which have gas inlets 161 through which the measurement gas is admitted into a gas chamber to which the sensing portion of the sensor element 2 is exposed.

The gas sensor 1 also has, as clearly illustrated in FIG. 4, an atmospheric-side porcelain insulator 12 placed on the porcelain insulator 3. Within the atmospheric-side porcelain insulator 12, metallic terminals 121 are disposed which make electrical contacts with the electrode terminals 223 and 233 of the sensor element 2.

The gas sensor 1 also includes an air cover 13 joined to a base end (i.e., an upper end, as viewed in FIG. 4) of the housing 4 to surround the atmospheric-side porcelain insulator 12. A rubber bush 131 is fit hermetically in a base end of the air cover 13. Electrical leads 122 leading to the metallic terminals 121 extend through the rubber bush 131.

The air cover 13 has air inlets 132 formed therein between the atmospheric-side porcelain insulator 12 and the rubber bush 131.

The feature of the structure of the gas sensor 1 of this embodiment will be described below in detail.

The base end 251 of the porous protective layer 25 is, as described above, located closer to the base end of the porcelain insulator 3 than the top end 31 of the porcelain insulator 3. In other words, the sensing portion of the sensor element 2 directly exposed to the measurement gas is covered fully with the porous protective layer 25. The porous protective layer 25 works to trap foreign matter, e.g., residual matter, such as carbon, contained in exhaust emissions from the automotive internal combustion engine, thereby minimizing the deposition of the foreign matter on the measurement gas electrode 221 and the lead 222 extending therefrom which is one of factors causing the separation of the lead 222 from the solid electrolyte layer 21.

The protruding distance L1 by which the dense protective layer 24 protrudes from the base end 251 of the porous protective layer 25 is, as described above, 5 mm or less. This minimizes the separation of the lead 222 extending from the measurement gas electrode 221 arising from the entrance of water into the lead 222. For instance, in production processes of the gas sensor 1, the lead 222 is exposed to water, so that it may enter the lead 222. When the moisture in the lead 222 is vaporized during heat treatment of the sensor element 2, it expands within the lead 222. If the lead 222 is covered almost fully with the dense protective layer 24, the water vapor will have nowhere to escape from the lead 222, which may result in breakage of the dense protective layer 24 and separation or breakage of the lead 222.

The porous protective layer 25 covers most of the dense protective layer 24 to enhance the mechanical strength of the dense protective layer 24, thus causing the water vapor, as produced in the lead 222, to escape from a portion of the lead 222 not covered with the dense protective layer 24. A portion of the dense protective layer 24 not covered with the porous protective layer 25, however, may lack the mechanical strength required to withstand the pressure of water vapor, as produced in the lead 222. In order to minimize this affair, the sensor element 2 of this embodiment is designed to set the protruding distance L1 by which the dense protective layer 24 protrudes from the base end 251 of the porous protective layer 25 to 5 mm or less to minimize the portion of the dense protective layer 24 not covered with the porous protective layer 25. This minimizes the separation of the lead 222 from the solid electrolyte layer 21.

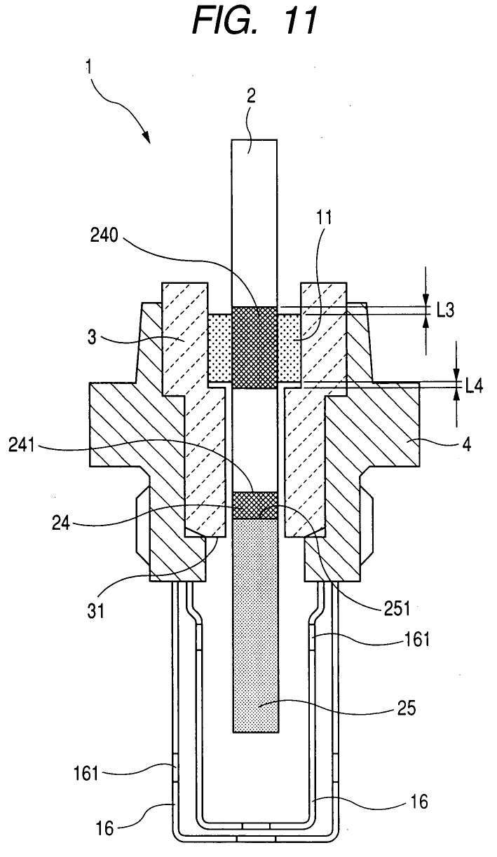

FIG. 11 shows the gas sensor 1 according to the second embodiment of the invention which is different from the first embodiment in that an outer area of the sensor element 2 placed in contact with the glass sealing member 11 is covered with a dense protective layer 240. The dense protective layer 240 is the same in structure as the dense protective layer 24. The dense protective layer 240 protrudes from a base end and a top end of the glass sealing member 11 by distances L1 and L2, respectively, which are 5 mm or less. Other arrangements are identical with those in the first embodiment, and explanation thereof in detail will be omitted here.

The installation of the glass sealing member 11 in the porcelain insulator 3 is achieved by stuffing glass powder into the base end portion of the porcelain insulator 3 and melting and then cooling it until it solidifies. When solidified, the glass usually shrinks, If the glass (i.e. the glass sealing member 11) is placed in direct abutment with the lead 222, it will, therefore, cause the lead 222 to be pulled partially by the glass when solidified, so that it may be separated or broken. The porous protective layer 240 serves to isolate the lead 222 from the glass sealing member 11 to avoid the separation of the lead 222 arising from the pulling thereof by the glass sealing member 11 when solidified.

The protruding distances L1 and L2 the dense protective layer 240 protrudes from the base and top ends of the glass sealing member 11 are, as described above, 5 mm or less, thereby minimizing the breakage of the dense protective layer 240 arising from the expansion of moisture within the lead 222 to avoid the separation of the lead 222 from the solid electrolyte layer 21.

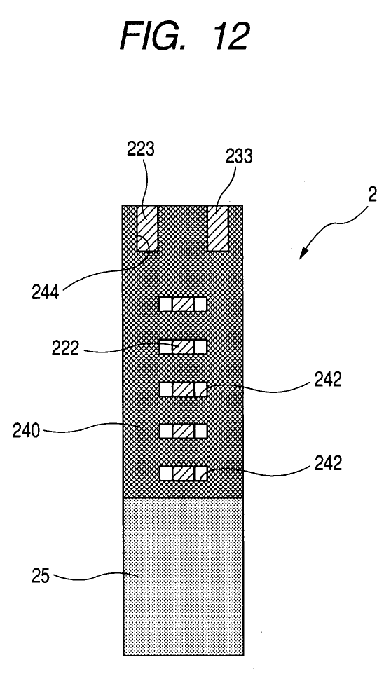

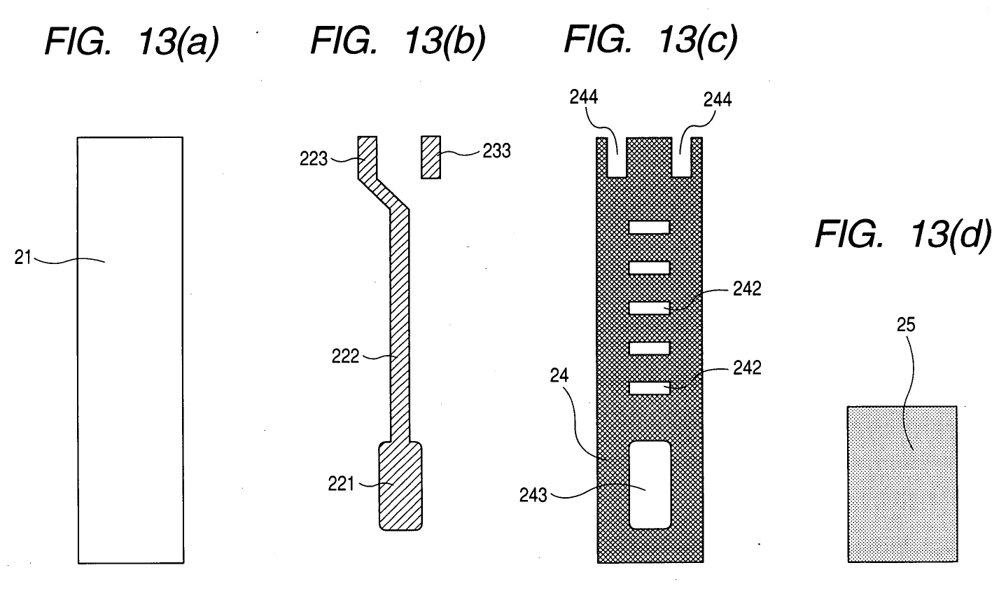

FIGS. 12 to 13(d) illustrate the sensor element 2 which is to be installed in the gas sensor 1 according to the third embodiment of the invention.

The sensor element 2 includes the dense protective layer 24, as illustrated in FIG. 13(c), which has the same size as that of the solid electrolyte layer 21 to cover, as illustrated in FIG. 12, the whole of the surface of the solid electrolyte layer 21. The dense protective layer 24, therefore, also occupies, like the one of FIG. 11, an outer area of the sensor element 2 placed in contact with the glass sealing member 11.

The dense protective layer 24 has openings 243 and 244 through which the measurement gas electrode 221 and electrode terminals 223 and 233 are exposed. The dense protective layer 24 also has a plurality of openings 242 arrayed in parallel in a lengthwise direction thereof. Each of the openings 242 extends to traverse the length of the lead 222 and expose the lead 222 partially. Each of the openings 242 is rectangular in shape, but may alternatively be circular, oval, or other shape. The number of the openings 242 may be at least one.

The openings 242 serve to permit the water vapor, as developed in the lead 222 when the sensor element 2 is subjected to the heat treatment, to escape outside the dense protective layer 24, thus minimizing the breakage of the dense protective layer 24 arising from the expansion of the moisture to avoid the separation of the lead 222 from the solid electrolyte layer 21.

Other arrangements are identical with those in the first embodiment, and explanation thereof in detail will be omitted here.

We analyzed a relation between the protruding distance L1 in the gas sensor 1 of the first embodiment and the percentage of separation of the dense protective layer 24 from the solid electrolyte layer 21.

We prepared test samples which were substantially identical in structure with the gas sensor 1 of the first embodiment, but had different values of the protruding distance L1 which were selected from between 0 to 20 mm. The test samples were also broken down into three types which were 10 μm, 20 μm, and 30 μm in thickness of the dense protective layer 24.

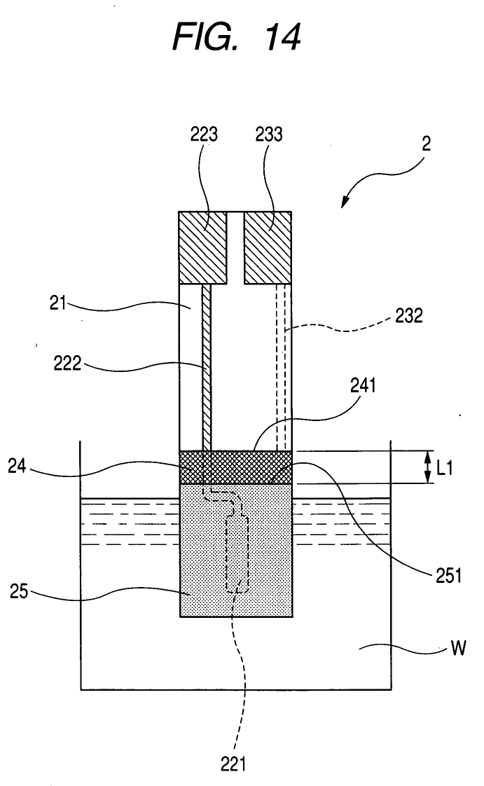

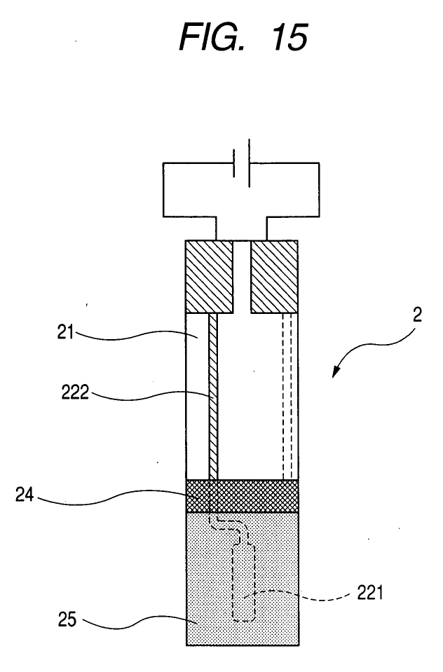

First, we placed, as illustrated in FIG. 14, each of the test samples in a water bath with the measurement gas electrode 221 placed fully within the water W for four hours.

Next, we applied, as illustrated in FIG. 15, 14V to the heater 28 to heat the test sample for one minute and then observed whether a portion of the dense protective layer 24 covering the lead 222 had been separated from the solid electrolyte layer 21 or not using a ten-power magnifying glass.

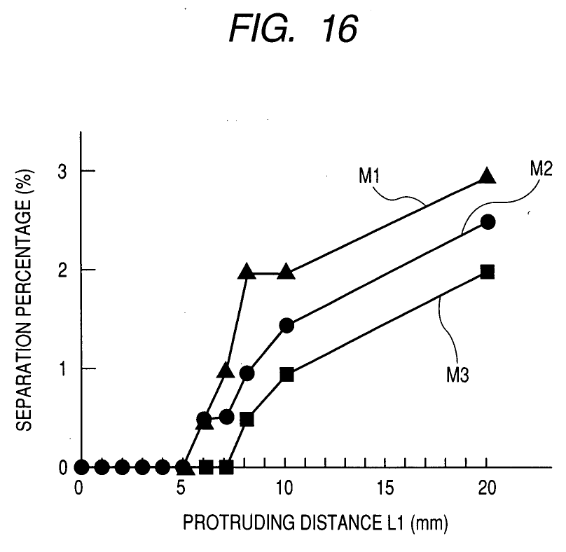

FIG. 16 shows results of the tests. The vertical axis represents in percentage the number of ones of the test samples in which the lead 222 is separated from the solid electrolyte layer 21. The total number of the test samples is two hundreds. The horizontal axis represents the protruding distance L1. Lines M1, M2, and M3 indicate groups of the test samples which are 10 μm, 20 μm, and 30 μm in thickness of the dense protective layer 24.

The graph of FIG. 16 shows that when the thickness of the dense protective layer 24 is, for example, 10 μm, and the protruding distance L1 is more than 5 mm, the test samples will undergo the separation of the lead 222 and that the separation percentage increases with an increase in the protruding distance L1. It is, therefore, found that when the protruding distance L1 is 5 mm or less, it ensures the stability of adhesion of the lead 222 to the solid electrolyte layer 21.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas sensor having a length with a top end and a base end opposite the top end, comprising:
a sensor element responsive to a concentration of a given gas to output a signal indicative thereof, said sensor element having a length with a top end and a base end opposite the top end;
a porcelain insulator in which said sensor element is retained with the top end thereof oriented to the top end of the gas sensor and the base end thereof oriented to the base end of the gas sensor; and
a housing in which said porcelain insulator is retained,
wherein said sensor element includes an oxygen ion-conductive solid electrolyte layer with a first and a second surface opposed to each other, a measurement gas electrode which is formed on the first surface of said ion-conductive solid electrolyte layer to be exposed to the gas and has a top end lying on a side of the top end of said sensor element and a base end lying on a side of the base end of the said sensor element, a measurement gas electrode lead extending from the base end of the measurement gas electrode, a reference gas electrode formed on the second surface of said ion-conductive solid electrolyte layer to be exposed to a reference gas, a dense protective layer covering the measurement gas electrode lead, and a porous protective layer disposed on said dense protective layer to cover said measurement gas electrode,
wherein said dense protective layer has a length with a top end lying on the side of the top end of said sensor element and a base end lying on the side of the base end of said sensor element, said porous protective layer having a length with a top end lying on the side of the top end of said sensor element and a base end lying on the side of the base end of said sensor element, the base end of said dense protective layer protruding from the base end of said porous protective layer by a distance of 5 mm or less, and
wherein the base end of the porous protective layer lies inside said porcelain insulator.

2. A gas sensor as set forth in claim 1, further comprising a sealing member and a second dense protective layer, said sealing member being disposed within said porcelain insulator to form a hermetic seal between said sensor element and said porcelain insulator, the second dense protective layer being interposed between said sealing member and said sensor element.

3. A gas sensor as set forth in claim 2, wherein said second dense protective layer has a length with a top end lying on the side of the top end of said sensor element and a base end lying on the side of the base end of said sensor element, each of the base end and the top end of said second dense protective layer protruding from said sealing member by a distance of 5 mm or less.

4. A gas sensor having a length with a top end and a base end opposite the top end, comprising:
a sensor element responsive to a concentration of a given gas to output a signal indicative thereof, said sensor element having a length with a top end and a base end opposite the top end;
a porcelain insulator in which said sensor element is retained with the top end thereof oriented to the top end of the gas sensor and the base end thereof oriented to the base end of the gas sensor; and
a housing in which said porcelain insulator is retained,
wherein said sensor element includes an oxygen ion-conductive solid electrolyte layer with a first and a second surface opposed to each other, a measurement gas electrode which is formed on the first surface of said ion-conductive solid electrolyte layer to be exposed to the gas and has a top end lying on a side of the top end of said sensor element and a base end lying on a side of the base end of the said sensor element, a measurement gas electrode lead extending from the base end of the measurement gas electrode, a reference gas electrode formed on the second surface of said ion-conductive solid electrolyte layer to be exposed to a reference gas, a dense protective layer covering the measurement gas electrode lead, and a porous protective layer disposed on said dense protective layer to cover said measurement gas electrode, and
wherein said dense protective layer has an opening through which the measurement gas electrode lead partially exposed.

5. A gas sensor as set forth in claim 4, further comprising a sealing member disposed within said porcelain insulator to form a hermetic seal between said sensor element and said porcelain insulator, the dense protective layer occupying an area of said sensor element placed in contact with said sealing member.
